(19) United States
(12) Patent Application Publication
(10) Pub. No.: US 2009/0125341 A1
(43) Pub. Date: May 14, 2009

(54) Coordinating and managing the rental of parking spaces

(76) Inventors: John Raul Somoza, San Francisco, CA (US); Michael Somoza, San Mateo, CA (US)

Correspondence Address: LUMEN PATENT FIRM, 2345 YALE STREET, SECOND FLOOR, PALO ALTO, CA, 94306, US

(21) Appl. No.: 12/154,388

(22) Filed: May 21, 2008

Related U.S. Application Data
(60) Provisional application No. 60/931,305, filed on May 21, 2007.

(51) Int. Cl. G06Q 30/00; G06Q 10/00

(52) U.S. Cl. 705/5

(57) ABSTRACT

An internet-based parking space reservation and transaction method is provided that includes an internet platform having a server to provide a computer program to operate a virtual marketplace for parking transactions. At least one parking space lessor contacts the virtual marketplace to place a parking space in an available state and information including a money account, a space location, available time, and cost. At least one parking space lessee contacts the virtual marketplace to reserve the parking space and information including a money account, desired location, and beginning and ending lease time. A parking space availability list is provided to the lessee, having location and pricing. A lease agreement and fee exchange occurs when the lessee selects a desired the space. A fee to a money account of the marketplace is provided, where the lessor apportions a predetermined amount of the associated fee to the virtual marketplace money account.

### CROSS-REFERENCE TO RELATED APPLICATIONS

This application is cross-referenced to and claims the benefit from U.S. Provisional Patent Application 60/931,305 filed May 21, 2007, which is hereby incorporated by reference.

### FIELD OF THE INVENTION

The invention relates generally to methods and systems for renting parking spaces.

### BACKGROUND

Currently, parking spaces are primarily rented through the use of metered parking or through parking garages. Both methods are similar in that they require infrastructure at the site of the parking, either in the form of a parking meter (or similar device) or in the form of employees who monitor the parking transaction. Accordingly, there is a need to develop a method or system for coordinating and managing the rental of parking spaces for any type of vehicle (e.g. automobiles, motorcycles, mobile homes, trucks, boats, etc), in a convenient and efficient manner.

### SUMMARY OF THE INVENTION

The present invention is a method by which parking spaces are rented. The entire transaction takes place in an automated way, using an electronic reservation system composed of a computer equipped with a database, an application program and a method of communicating with clients. Communication with the electronic reservations system is through the Internet, through a phone or through a GPS-equipped device.

Anyone with a parking space to rent accesses the electronic reservation system and specifies information that includes: (1) the location of the space(s) to be rented; (2) the time(s) at which the rental is available; (3) the amount of money at which the parking space will be rented, and (4) any other relevant information about the parking space.

Customers looking for parking also access the electronic reservation system where they specify the time and location at which they wish to have parking. This invention then returns a list of available spots in the vicinity of the desired location along with information that includes the time(s) available for parking, the pricing information, the relative location of the parking space and the desired location, and any other relevant information about the parking space. The customer then is able to select a parking space and either reserve or immediately rent the space. When the customer commits to a parking space, the payment takes place online. Some of the money is paid to the provider and some is kept by the online parking service.

This invention provides a number of advantages over the way parking transactions are currently carried out. From the point of view of the parking provider, this invention provides two big advantages. First, the rental of a parking space can take place with no on-location infrastructure. Because of this, people who previously had no way of renting their parking are now able to do so. For example, homeowners are able to use the invention to rent out their garages and driveways, providing a new source of income for the homeowner as well as an entirely new source of parking. Similarly, stores and other commercial establishments are able to rent out their parking during periods when it is not needed. The second advantage for the parking providers is that they would have a simple way of renting their parking in advance. Currently, most parking rentals occur only when a customer arrives at the parking location. By using this invention, the parking provider (e.g. the owner of a parking lot) has the option of renting some of the parking in advance. Among other advantages, this allows the parking provider to charge different amounts of money for parking rented in advance compared to parking rented on-the-spot.

From the point of view of the parking customer, this invention allows the customer to reserve a parking space in advance, thus ensuring the availability of parking before starting a trip. In addition, because this invention increases the amount of available parking, it is likely that parking will become cheaper.

### BRIEF DESCRIPTION OF THE FIGURES

The objectives and advantages of the present invention will be understood by reading the following detailed description in conjunction with the drawing, in which:

FIG. 1 shows a flow diagram of the steps for providing parking space reservations and transactions according to the present invention.

### DETAILED DESCRIPTION OF THE INVENTION

Although the following detailed description contains many specifics for the purposes of illustration, anyone of ordinary skill in the art will readily appreciate that many variations and alterations to the following exemplary details are within the scope of the invention. Accordingly, the following preferred embodiment of the invention is set forth without any loss of generality to, and without imposing limitations upon, the claimed invention.

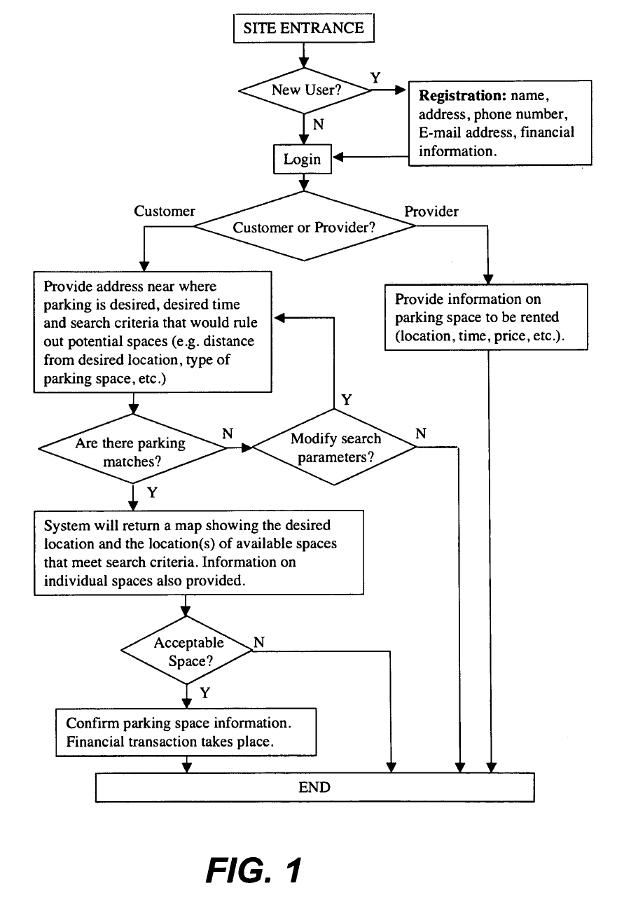

As described above, our invention describes a method for coordinating the renting of parking spaces (see schematic view of the system in FIG. 1). The rental transaction is coordinated automatically using a software application tied into a database and accessible through communication means that includes the internet (for example, through a web page), the phone system, and GPS devices.

Potential parking providers access the electronic reservation system, where they then are required to either log in (if they are previously registered users), or register for the parking service (if they are new users). As part of the registration process, the providers enter the following information: (1) name, (2) address, (3) E-mail address, and (4) phone number. As part of the registration, the parking provider provides financial information that is used to make payments to the provider or reimbursements to the customer. One possibility is using a system like Paypal for the financial transactions.

Once the potential parking provider has logged into the system, they provide the following information: date, time, location and price of parking that they wish to rent, along with a description of the parking space(s), including the type of space (e.g. garage, driveway, etc) and any other information that might determine the desirability of the parking space or the ability of the customer to find the parking space. All of the information entered is kept in a database accessible by the electronic reservation system's software application.

Potential parking customers start off by going through a similar registration process, in which they provide their name, address and financial information (to be used for automated payments for the parking). Once registered as users of the system they are able to log on, and after doing so provide information that includes: (1) location near where they would like parking, (2) the start and end times for the parking, (3) the maximum distance between the parking and the location that they specify, (4) the license plate of the car for which they would like parking, (5) any additional relevant information.

Based on the information provided by the parking providers and the customer, the parking system will search the database for parking matches (parking spaces within the specified distance and that are available at the desired time). If there is no match, the system will say so and will offer the possibility of expanding the search to different times or to a bigger distance between desired and actual location of the parking. If there is a match, the system will return a map that is centered at the customer-specified location and that shows the location of all available parking spaces. The customer will then examine each parking space in detail to see all relevant information about that space.

If the customer decides to choose a given parking space, he or she confirms the desired time. Once confirmed, the parking software confirms all relevant information about the chosen parking space, including a map showing both the specified location and the location of the chosen parking, a description of how to get from the parking space to the specified location, the time for which the parking is being reserved, the price for the parking, and the license plate number of the car that is being parked. At that point, the customer can choose to confirm the transaction and, if confirmed, the financial transaction will take place automatically between customer and provider, with some percentage going to the parking service. In addition, the parking provider will be notified of the transaction, probably through E-mail or through a text message.

The description above outlines the basic functioning of the invention. Other additional parts of the system are included to minimize any difficulties that might arise due, for example, to parking spaces not being available when specified or due to customers overstaying their reservation. To deal with these issues the invention incorporates a feedback feature, where both the customers and providers can provide feedback on each parking transaction. Providers or customers with consistent problems could be temporarily or permanently banned from using the system. In addition, the system could keep track of the rating of each renter and provider and this information could be provided for each potential parking transaction. Parking customers and providers could each have the option of rejecting a parking transaction based on rating. The provider could specify that he/she will only rent to customers with a threshold rating. In this case, only those customers with a rating better than the threshold will even see the corresponding parking spots. Similarly, a renter could specify that he/she only wants to see spaces provided by providers with a threshold rating. Finally, providers could block specific renters in such a way that those individual renters do not see his/her parking spots. In the same way, renters could block individual providers so that the corresponding parking spaces do not appear in their search results.

There are several extensions to the previously described invention that are included in subsequent embodiments of our invention.

In addition to mediating the renting of parking spaces for automobiles, one could expand the system to mediate the “parking” of the following items:
Boats (including but not limited to sailboats, powerboats, canoes, kayaks, and house boats). This requires additional specifications in terms of the length and size of the boat as well as any required utility hookups.
RVs and trucks. This requires additional information regarding the size of the RV/truck and hookups required.
Planes
Motorcycles
Bicycles
Any other vehicle that requires permanent or temporary parking

Types of communication interfaces between the customer and system of the invention include:
Web site
PDA
Cell phones (using voice messaging, text messaging, internet access and or bluetooth)
GPS devices equipped with the ability to receive information
Interface through web services (see details below)
Direct interfaces (see details below)

Web services refer to a set of application program interfaces (APIs) that could permit external systems to access the infrastructure provided by our invention. Web services allow outside groups to provide their own interfaces to the current invention. For example, they are able to tap into our parking database without having to pass through our user interface. Allowing outside individuals or organizations to make use of our infrastructure without passing through our user interface is essential for many of the extensions that we plan for our invention. In general, this allows outside organizations to use the functionality of the invention web site while providing their own user interface, branding, marketing, etc. In these cases, a fee is still charged for the user of our data and database. Several examples of this are given below:
A restaurant could offer parking through its own web site. The restaurant would use our invention to track parking spaces and could either make use of parking spaces from our general pool of spaces or could find their own set of spaces that could be tracked through our invention but reserved for the restaurant's use. The parking service would be mostly mediated by our invention, but the process would be transparent to the restaurant patron.
A company could essentially re-rent our spaces through their own interface with their own customers, marketing, branding, etc., while making use of our infrastructure to keep track of customers and to mediate the transaction.
A large organization with its own parking (e.g. a city government, a commercial establishment, etc) could rent out their parking through our system.

In mediating parking transactions, one embodiment of the invention mediates the parking transaction but not serve as the direct conduit between parking provider and customer. More specifically, the possibility exists of having the provider directly contact the parking customer while using the invention to keep track of the parking transaction and to mediate the financial transaction. Several examples are listed below, but are not limiting to the scope of the invention:
In the most basic scenario, the provider could directly advertise a parking space (using a sign posted on his/her driveway, for example), along with any relevant information about pricing, time limits, etc. The provider would specify that the transaction takes place with the help of our system and would specify a parking transaction code. Customers could then access our invention, go directly to the code-specified parking transaction and could pay in the normal way. This type of system is an advantage to the customer who did not reserve a parking space in advance. From the provider's point of view, this system could simply provide another and, in some cases better, way of advertising their site. In addition, providers could seek to rent their site both in the originally-specified way (by allowing the renter to reserve the spot), as well as directly to the customer. If a customer reserves a site by either means, our database could be updated to indicate that the spot was occupied. If the site is reserved through our online system, the sign would be removed during the reserved time slot.
The advertisement through a posted sign represents the simplest scheme but any direct advertising system is feasible. Renters could also signal the availability of parking through Bluetooth, text messaging, etc.

In addition, the method by which the parking transaction is agreed upon and the information is relayed to our system could be changed. For example a system could be used that would use Bluetooth or RFID communication to signal the customer's agreement with the conditions of the provider (in this implementation, both parties would need communication devices). The information on parking could be passed from the provider to the customer through Bluetooth onto the customer's cell phone. The customer could review the terms and if there is agreement, transmit that information to our system (the communication could either go through a text message from the user or could get transmitted to the provider, who would then automatically forward it to our system). In this situation, the customer would not necessary have to agree to a fixed length of time. He/she could signal agreement with the start of the parking period and later signal the end of the period.

One of the outcomes of the invention is that the method/system knows where our customers will be at certain times. In some cases, based on the desired location, the invention is also able to identify the reason for their visit. This information will be used in two ways:
Suggestions for things to do in area during the relevant time period. For example, if we can tell that a given customer is going to the museum, we can suggest other museums or cultural sites that are nearby. Similarly, if a customer is attending the opera (or any location at a time that matches breakfast, lunch or dinner times), we can suggest nearby restaurants.
Advertisements specific to time/location. Similar to the ideas described above, we will include paid advertisements for establishments that are in the vicinity of the parking location.

The present invention has now been described in accordance with several exemplary embodiments, which are intended to be illustrative in all aspects, rather than restrictive. Thus, the present invention is capable of many variations in detailed implementation, which may be derived from the description contained herein by a person of ordinary skill in the art. For example this parking method will include one-time parking as well as ongoing parking (weekly, monthly, indefinite, etc.). The system will alert users (e.g. using text messaging or other digital messaging systems) when their space is about to expire. If they wish to extend parking and if the parking space is available beyond the originally specified time, the renter will be given the option of extending parking (see below). The invention will allow the renter to extend a reservation, assuming that the space is available beyond the time period that they have reserved. The renter would communicate their intent to extend the reservation by sending some form of communication to the system, such as sending a text message with an identification code and the amount of time by which they would like to extend the reservation. We also may provide a cancel feature that would allow the renter to cancel the reservation if they are done with the space before their reservation period has ended.

All such variations are considered to be within the scope and spirit of the present invention as defined by the following claims and their legal equivalents.

What is claimed:

1. An internet-based parking space reservation and transaction method comprising:
a. providing an internet platform, wherein said internet platform comprises at least one server connected to said internet, whereby said server provides a computer program, whereas said program operates a virtual marketplace for parking transactions;
b. providing at least one parking space lessor, wherein said lessor contacts said virtual marketplace to place a parking space in an available state, whereby said lessor provides information to said marketplace comprising:
i. a lessor money account;
ii. a location of said space;
iii. an available time of said space; and
iv. a cost for use of said space;
c. providing at least one parking space lessee, wherein said lessee contacts said virtual marketplace to reserve said parking space, whereby said lessee provides information to said marketplace comprising:
i. a lessee money account;
ii. a desired location; and
iii. a beginning lease time and an ending lease time,
whereby said lessee contacts said marketplace by computer, phone, GPS or any other device connected to the network;
d. providing a parking space availability list to said lessee, wherein said availability list comprises:
i. a list of available spaces, wherein spaces on said list are near said desired location; and
ii. a pricing list, wherein each price on said pricing list is associated with one said space on said list of available spaces;
e. providing a lease agreement and fee exchange, wherein said lessee selects a desired said space, whereby said lessee provides a fee to said lessor money account, whereas said fee is according to said associated price; and
f. providing a fee to a money account of said marketplace, wherein said lessor apportions a predetermined amount of said associated fee to said virtual marketplace money account.
